(19) United States
(12) Patent Application Publication
(10) Pub. No.: US 2026/0015467 A1
(43) Pub. Date: Jan. 15, 2026

(54) PREPARATION METHOD OF MICRONIZED POLYOLEFIN COPOLYMER AND POLYOLEFIN COPOLYMER DRY MICRO POWDER

(71) Applicant: POLYALLOY INC., New Taipei City (TW)

(72) Inventor: Yi-Ko CHEN, New Taipei City (TW)

(21) Appl. No.: 18/767,561

(22) Filed: Jul. 9, 2024

(51) Int. Cl. C08J 3/12; C08J 3/07

(52) U.S. Cl. CPC C08J 3/12; C08J 3/07; C08J 2351/06

(57) ABSTRACT

A preparation method of micronized polyolefin copolymer includes the steps of: performing functional group reactive grafting on a polyolefin resin to become a polyolefin resin containing unsaturated carboxylic acid; putting the polyolefin resin containing unsaturated carboxylic acid into a co-rotating twin screw extruder; heating the polyolefin resin to a molten state by the extruder; dissolving a surfactant in water and stirring until dissolved, then injecting the surfactant into the extruder through a high-pressure pump to continuously mix the polyolefin resin and water with high shear; the particle size of polyolefin resin becomes smaller and smaller with screw shear, eventually reaching extremely small particles and evenly dispersed in water, forming aqueous polyolefin dispersion; finally, rapidly cooling the aqueous polyolefin dispersion.

### BACKGROUND OF THE INVENTION

### 1. Field of the Invention

The present invention relates to a preparation method of micronized polyolefin copolymer especially preparation method of micronized polyolefin copolymer and polyolefin copolymer dry micro powder to process polyolefin resin into an aqueous polyolefin dispersion or polyolefin copolymer dry micro powder without using cryogenic grinding and solvent method.

### 2. Description of the Related Art

According to reports, polyolefin is a polymer with the general formula (CH₂CHR)n, where R is an alkyl group. They are usually derived from a group of simple olefins, forming different polyolefin types according to different olefin structures. In the industry, TPO (Thermoplastic polyolefin) is often used to refer to all such materials. Among polymer materials, polyolefin materials have been widely used commercially due to their light weight, easy processing, and excellent physical properties. Commercially available polyolefin materials are in the form of granular substance with particle size around 3-5 mm, and cannot be processed at room temperature. They must be heated and melted to flow plasticity (70˜150° C., depending on specifications). It is difficult to achieve low thickness that uses polyolefin as a barrier layer of porous materials by lamination process. There is also a processing bottleneck in the coating process.

In addition, due to the low polarity and low free radicals in the chemical structure of polyolefin, insufficient wetting happens between polyolefin and other materials, making it difficult to adhere to other materials. It usually requires toxic solvents (toluene, xylene) or halogen polymer (chlorinated polyolefin) materials to achieve the purpose of adhesion with other materials. Besides causing environmental and labor safety issues, the adhesive used may also limit the recycling of finished products after use in the future. The most common method to reduce the particle size of polyolefin is cryogenic grinding. Since the melting point of polyolefin is low, room temperature grinding will cause the material to melt due to friction heat and cannot maintain granular. Liquid nitrogen is commonly used to cool down to prevent polyolefin from melting. However, even if cryogenic grinding is used, the particle size and shape are difficult to be unified and the equipment and production costs are extremely high which make it difficult to be commercialized. In addition, although the solvent methods can achieve the purpose of micronization, but the solvents that can dissolve polyolefin are highly dangerous and will cause more cost and environmental problems.

### SUMMARY OF THE INVENTION

The invention provides a method for preparing micronized polyolefin copolymer, which is particularly suitable for processing polyolefin resins into an aqueous polyolefin dispersion without using cryogenic grinding.

The invention provides a method for preparing micronized polyolefin copolymer, which is particularly suitable for processing a polyolefin resin into a polyolefin aqueous dispersion without using cryogenic grinding. The preparation method of micronized polyolefin copolymer comprises the steps of: S110: perform functional group reactive grafting on a polyolefin resin to become a polyolefin resin containing unsaturated carboxylic acid; S120: put the polyolefin resin containing unsaturated carboxylic acid into a co-rotating twin screw extruder; S130: dissolve a surfactant in water and stir until dissolved, then inject the aqueous surfactant solution thus obtained into the co-rotating twin screw extruder through a high-pressure pump; S140: perform continuous high shearing on the polyolefin resin containing unsaturated carboxylic acid in water through the co-rotating twin screw extruder, so that the polyolefin resin containing unsaturated carboxylic acid is mixed with water in a molten state; S150: the polyolefin resin containing unsaturated carboxylic acid forms tiny particles and is evenly dispersed in water to form an aqueous polyolefin dispersion; and S160: rapidly cool the aqueous polyolefin dispersion.

In one embodiment of the present invention, in the step of performing functional group reactive grafting on the polyolefin resin, the polyolefin resin is combined with maleic anhydride or methacrylic acid to perform functional group reactive grafting.

In one embodiment of the present invention, the polyolefin resin is ethylene-propylene copolymer.

In one embodiment of the present invention, the aqueous polyolefin dispersion is polyolefin particles dispersed in water and the particle size is less than 10 microns.

In one embodiment of the present invention, the solid content of polyolefin in the aqueous polyolefin dispersion is 40˜60 wt %, and the viscosity is 300˜80,000 centipoise (cP).

In one embodiment of the present invention, in step S140, in the environment of continuous high shear of the co-rotating twin screw extruder, surfactant is used to prevent it from forming a continuous phase again, and then its particle size becomes smaller and smaller with screw shear.

The invention provides a method for preparing polyolefin copolymer dry micro powder, which is particularly suitable for processing a polyolefin resin into a polyolefin copolymer dry micro powder without using cryogenic grinding. The preparation method of polyolefin copolymer dry micro powder comprises the steps of: S210: perform functional group reactive grafting on a polyolefin resin to become a polyolefin resin containing unsaturated carboxylic acid; S220: put the polyolefin resin containing unsaturated carboxylic acid into a co-rotating twin screw extruder; S230: dissolve a surfactant in water and stir until dissolved, then inject the aqueous surfactant solution thus obtained into the co-rotating twin screw extruder through a high-pressure pump; S240: perform continuous high shearing on the polyolefin resin containing unsaturated carboxylic acid in water through the co-rotating twin screw extruder, so that the polyolefin resin containing unsaturated carboxylic acid is mixed with water in a molten state; S250: the polyolefin resin containing unsaturated carboxylic acid forms tiny particles and is evenly dispersed in water to form an aqueous polyolefin dispersion; S260: rapidly cool the aqueous polyolefin dispersion; and S270: remove the moisture of the aqueous polyolefin dispersion through a dehydration process to obtain the polyolefin copolymer dry micro powder.

In summary, the preparation method of micronized polyolefin copolymer and polyolefin copolymer dry micro powder disclosed in the present invention can achieve the following effects:
1. It can achieve a coating with extremely low thickness of film, and micronized polyolefin can penetrate deeply into porous materials and then be formed into a film through the subsequent hot press process to make up for its shortcomings of difficulty in adhesion.
2. It can be used in coating, dipping, spraying and other processes, and can be regarded as a water-based paint or water-based adhesive.
3. It still retains its properties as a thermoplastic resin, has flow plasticity at a specific temperature (resin melting point), has excellent film forming properties, and polyolefin with polar group has excellent compatibility with a variety of common resins, such as polyamide and polyester, and compared with cross-linking reactive adhesives, it can make the finished product easier to recycle in the future.
4. The micronized polyolefin copolymer dry micro powder can be mixed with other powder materials, such as cement, ceramics or metals, for waterproofing, sintering or adhesion purposes.
5. Polyolefin copolymer dry micro powder mixed with natural fibers can act as adhesive, which can significantly reduce the resin content in the finished product.

It will be easier to understand the purpose, technical content, characteristics and achieved effects of the present invention through detailed description of specific embodiments below.

### BRIEF DESCRIPTION OF THE DRAWINGS

FIG. 1 is a flow chart of the preparation method of micronized polyolefin copolymer of the present invention.

FIG. 2 is a display diagram of the present invention when observing particles of aqueous polyolefin dispersion under a scanning electron microscope.

FIG. 3 is a flow chart of the preparation method of polyolefin copolymer dry micro powder of the present invention.

### DETAILED DESCRIPTION OF THE PREFERRED EMBODIMENT

After years of research and development, the inventor has improved the criticisms of existing products. The following will introduce in detail how the present invention achieves the most efficient functional requirements through a preparation method of micronized polyolefin copolymer and polyolefin copolymer dry micro powder.

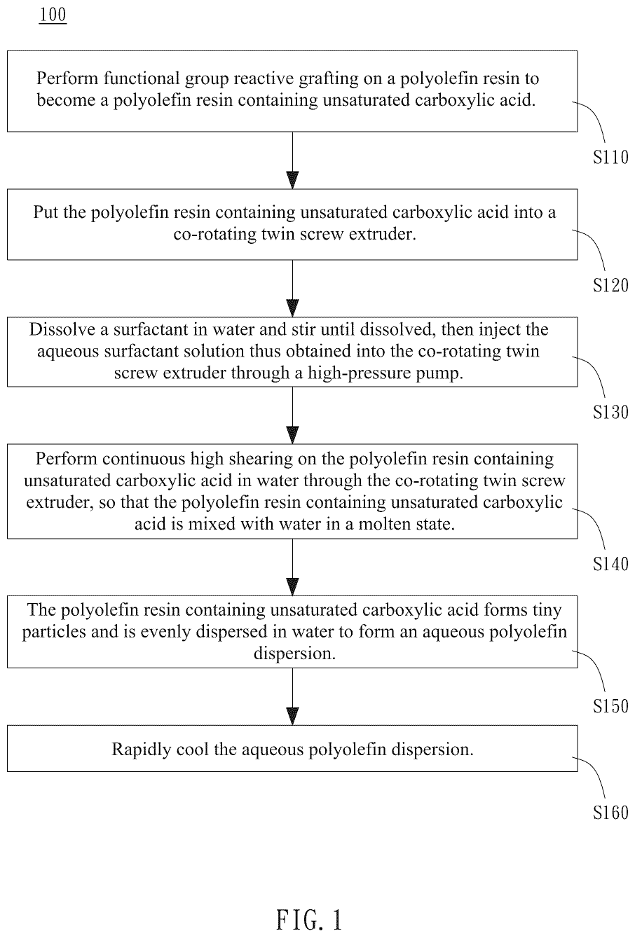

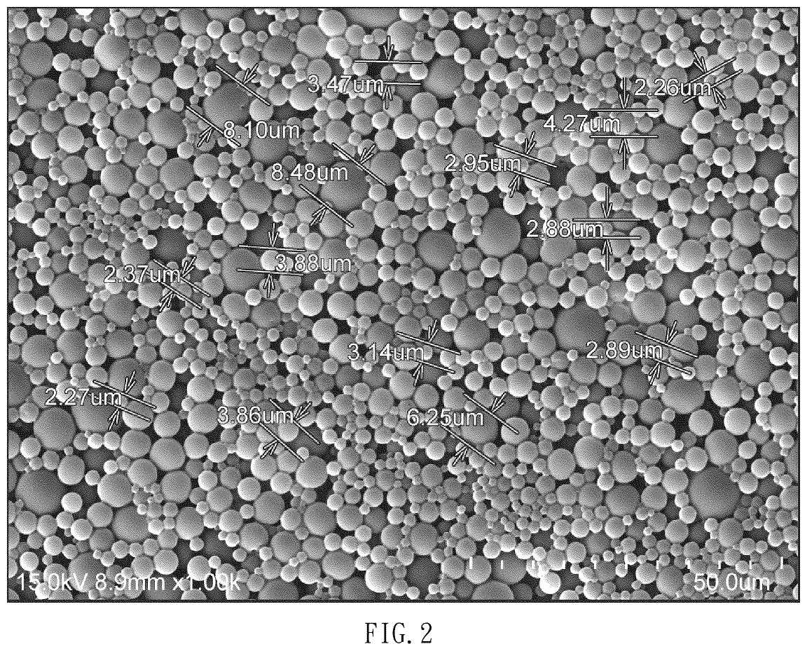

Please refer to FIGS. 1 and 2, wherein FIG. 1 is a flow chart of the preparation method of micronized polyolefin copolymer of the present invention, and FIG. 2 is a display diagram of the present invention when observing particles of aqueous polyolefin dispersion under a scanning electron microscope.

The present invention mainly uses polyolefin containing unsaturated carboxylic acid to reach a micronized state through continuous shearing in water, thereby producing polyolefin particles dispersed in water. The particle size is less than 10 microns (μm), and the resulting aqueous polyolefin dispersion or powder after removing the water has its commercial uses. Furthermore, the present invention mainly micronizes the polyolefin material connected with the functional group and disperses it in water, which allows the polyolefin resin to be coated at room temperature. Due to the low viscosity of the aqueous solution, a coating with extremely low thickness of film can be achieved. The micronized polyolefin can penetrate deeply into the porous material and then form a film through the subsequent hot pressing process, making up for its shortcomings of difficulty in adhesion. This approach retains the thermoplastic properties of polyolefin materials, and polyolefin with polar group has excellent compatibility with a variety of common resins, such as polyamide and polyester. Compared with cross-linking reactive adhesives, the finished product can be more easily recycled in the future. In addition, the micronized polyolefin copolymer dry micro powder can be mixed with other powder materials, such as cement, ceramics or metals, for waterproofing, sintering or adhesion purposes.

In detail, as shown in FIG. 1, in the embodiment of the present invention, the preparation method 100 of micronized polyolefin copolymer is particularly suitable for processing a polyolefin resin into an aqueous polyolefin dispersion without using cryogenic grinding method and without using solvent method. The preparation method of micronized polyolefin copolymer comprises the steps of: S110: perform functional group reactive grafting on a polyolefin resin to become a polyolefin resin containing unsaturated carboxylic acid; S120: put the polyolefin resin containing unsaturated carboxylic acid into a co-rotating twin screw extruder; S130: dissolve a surfactant in water and stir until dissolved, then inject the aqueous surfactant solution thus obtained into the co-rotating twin screw extruder through a high-pressure pump; S140: perform continuous high shearing on the polyolefin resin containing unsaturated carboxylic acid in water through the co-rotating twin screw extruder, so that the polyolefin resin containing unsaturated carboxylic acid is mixed with water in a molten state; S150: the polyolefin resin containing unsaturated carboxylic acid forms tiny particles and is evenly dispersed in water to form an aqueous polyolefin dispersion; and S160: rapidly cool the aqueous polyolefin dispersion.

In the initial step S110, the polyolefin resin is combined with maleic anhydride or methacrylic acid for functional group reactive grafting, so that the polyolefin resin is carried with unsaturated carboxylic acid, wherein the polyolefin resin is ethylene-propylene copolymer. After that, step S120 is entered. This step mainly requires the use of a co-rotating twin screw extruder equipment, that is, the polyolefin resin containing unsaturated carboxylic acid i put into the co-rotating twin screw extruder. Afterwards, proceeding to steps S130 and S140, the surfactant and water are introduced into the co-rotating twin screw extruder, and the polyolefin resin containing unsaturated carboxylic acid is mixed with water in a molten state. After that, under the continuous high shear environment of the co-rotating twin screw extruder, the surfactant is used to prevent it from forming a continuous phase, and then the particle size of the polyolefin particles becomes smaller and smaller with the screw shear. Finally, the polyolefin particles are evenly dispersed in water to form the aqueous polyolefin dispersion. It is worth mentioning that in this aqueous polyolefin dispersion, the particle size of the polyolefin particles is less than 10 microns. The solid content of aqueous polyolefin dispersion obtained by the above process can be controlled between 40 and 60 wt %. Furthermore, the viscosity of the aqueous polyolefin dispersion changes with the polyolefin solid content. That is to say, if the polyolefin solid content of the produced aqueous polyolefin dispersion is 60 wt %, the viscosity of the aqueous polyolefin dispersion will be as high as about 80,000 centipoise (cP). The present invention can simply add water to the aqueous polyolefin dispersion to change the polyolefin solid content, and then adjust the viscosity of the aqueous polyolefin dispersion to meet different application requirements. If the application area is low viscosity, just add water to dilute the polyolefin solid content to 45-50 wt %, and the viscosity can be reduced to 2000-3500 centipoise (cP), and so on. The aqueous polyolefin dispersion in the present invention is polyolefin copolymer dispersed in water in a spherical shape with a particle size of 1 to 10 μm. The more uniform the particle size, the more stable the viscosity, which is very important to the quality of the finished product. After that, step S160 is entered. At this point, the polyolefin copolymer (ethylene-propylene copolymer or polyolefin resins) has been sheared into extremely small particles by the co-rotating twin screw extruder. In order to prevent the particles from re-merging, the aqueous polyolefin dispersion needs to be rapidly cooled. The rapid time and cooling temperature are determined according to the specific conditions of the aqueous polyolefin dispersion. Because the amount of aqueous polyolefin dispersion also depends on the actual production situation, so that the finished product can be dispersed in water in the form of particles with a particle size of 1˜10 μm. Next, as shown in FIG. 2, the aqueous polyolefin dispersion is observed under a scanning electron microscope, and it can be seen that the polyolefin particle size has been reduced to 1˜10 μm by processing. This also shows that the preparation method of micronized polyolefin copolymer disclosed in the present invention is indeed implementable.

The spirit of this embodiment is as follows: to micronize the polyolefin material, water needs to be used as the medium. In the co-rotating twin screw extruder, reactive grafting is first performed to give the polyolefin material a carboxylic acid. When the material is in a molten state, pure water and surfactant are injected, and with the continuous high shear of the co-rotating twin screw extruder and the assistance of the surfactant, the particle size of polyolefin is quickly and significantly reduced, resulting in the finished product of aqueous polyolefin dispersion. The micronized aqueous polyolefin dispersion of the present invention can be used in coating, dipping, spraying and other processes, and can be regarded as a water-based paint or water-based adhesive. In addition to the reduction in particle size, it still retains its thermoplastic characteristics, has flow plasticity at a specific temperature (resin melting point), and has excellent film forming properties.

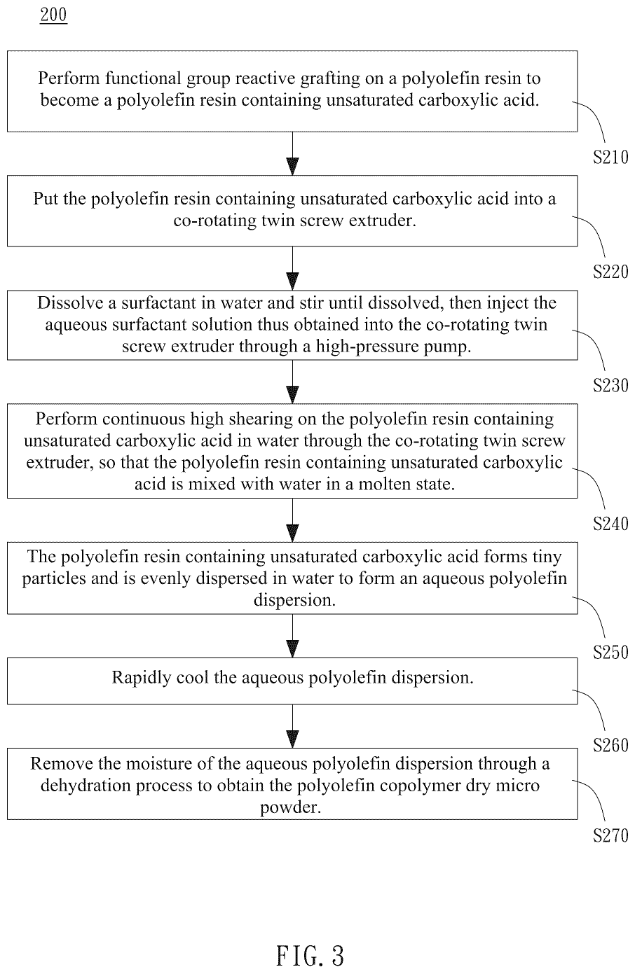

Next, please refer to FIG. 3, which is a flow chart of the preparation method of polyolefin copolymer dry micro powder of the present invention. As shown in the figure, the preparation method of polyolefin copolymer dry micro powder is particularly suitable for processing a polyolefin resin into polyolefin copolymer dry micro powder without using cryogenic grinding and solvent methods.

The preparation method of polyolefin copolymer dry micro powder comprises the steps of: S210: perform functional group reactive grafting on a polyolefin resin to become a polyolefin resin containing unsaturated carboxylic acid; S220: put the polyolefin resin containing unsaturated carboxylic acid into a co-rotating twin screw extruder; S230: dissolve a surfactant in water and stir until dissolved, then inject) the aqueous surfactant solution thus obtained into the co-rotating twin screw extruder through a high-pressure pump; S240: perform continuous high shearing on the polyolefin resin containing unsaturated carboxylic acid in water through the co-rotating twin screw extruder, so that the polyolefin resin containing unsaturated carboxylic acid is mixed with water in a molten state; S250: the polyolefin resin containing unsaturated carboxylic acid forms tiny particles and is evenly dispersed in water to form an aqueous polyolefin dispersion; S260: rapidly cool the aqueous polyolefin dispersion; and S270: remove the moisture of the aqueous polyolefin dispersion through a dehydration process to obtain the polyolefin copolymer dry micro powder. It should be noted that the embodiment in FIG. 3 is mainly a continuation of the embodiment in the FIG. 1, which mainly adds the dehydration process of step S270 to allow the aqueous polyolefin dispersion to remove moisture to form polyolefin copolymer dry micro powder. The polyolefin copolymer dry micro powder in the embodiments of the present invention can have different advantages and application scenarios. That is to say, after removing water through dehydration process or drying process, polyolefin copolymer dry micro powder with uniform particle size and tiny particles can be obtained. If the polyolefin copolymer dry micro powder of the present invention is mixed with different powder materials, it can meet a wider range of industrial applications, such as mixing with cement mortar to improve its waterproof performance. The polyolefin copolymer dry micro powder of the present invention can be used as adhesive when mixed with natural fibers, and can significantly reduce the resin content in the finished product.

In addition, the polyolefin copolymer dry micro powder (fine powder) can be obtained by drying aqueous polyolefin dispersion. Compared with cryogenic grinding, particle size distribution is more concentrated, and energy consumption and cost are lower. In addition, the polyolefin copolymer micro powder can be mixed with other non-resin materials for adhesive, barrier, waterproofing and other applications.

In summary, the preparation method of micronized polyolefin copolymer and polyolefin copolymer dry micro powder disclosed in the present invention can achieve the following effects:
1. It can achieve a coating with extremely low thickness of film, and micronized polyolefin can penetrate deeply into porous materials and then be formed into a film through the subsequent hot press process to make up for its shortcomings of difficulty in adhesion.
2. It can be used in coating, dipping, spraying and other processes, and can be regarded as a water-based paint or water-based adhesive.
3. It still retains its properties as a thermoplastic resin, has flow plasticity at a specific temperature (resin melting point), has excellent film forming properties, and polyolefin with polar group has excellent compatibility with a variety of common resins, such as polyamide and polyester, and compared with cross-linking reaction adhesives, it can make the finished product easier to recycle in the future.
4. The micronized polyolefin copolymer dry micro powder can be mixed with other powder materials, such as cement, ceramics or metals, for waterproofing, sintering or adhesion purposes.
5. Polyolefin copolymer dry micro powder mixed with natural fibers can act as adhesive, which can significantly reduce the resin content in the finished product.

What the invention claimed is:

1. A preparation method of micronized polyolefin copolymer suitable for processing polyolefin resins into an aqueous polyolefin dispersion with no use of cryogenic grinding, the preparation method of micronized polyolefin copolymer comprising the steps of:
S110: performing functional group reactive grafting on a polyolefin resin to become a polyolefin resin containing unsaturated carboxylic acid;
S120: putting said polyolefin resin containing unsaturated carboxylic acid into a co-rotating twin screw extruder;
S130: dissolving a surfactant in water and stirring until dissolved, then injecting the aqueous surfactant solution thus obtained into said co-rotating twin screw extruder through a high-pressure pump;
S140: performing continuous high shearing on said polyolefin resin containing unsaturated carboxylic acid in water through said co-rotating twin screw extruder, so that said polyolefin resin containing unsaturated carboxylic acid is mixed with water in a molten state;
S150: said polyolefin resin containing unsaturated carboxylic acid forming tiny particles and being evenly dispersed in water to form an aqueous polyolefin dispersion; and
S160: rapidly cooling said aqueous polyolefin dispersion.

2. The preparation method of micronized polyolefin copolymer as claimed in claim 1, wherein in the step of performing functional group reactive grafting on said polyolefin resin, said polyolefin resin is selectively combined with maleic anhydride or methacrylic acid to perform functional group reactive grafting.

3. The preparation method of micronized polyolefin copolymer as claimed in claim 1, wherein said polyolefin resin is ethylene-propylene copolymer.

4. The preparation method of micronized polyolefin copolymer as claimed in claim 1, wherein said aqueous polyolefin dispersion is formed of polyolefin particles dispersed in water and the particle size is less than 10 microns.

5. The preparation method of micronized polyolefin copolymer as claimed in claim 1, wherein the polyolefin in said aqueous polyolefin dispersion has a solid content of 40˜60 wt % and a viscosity of 300˜80,000 centipoise (cP).

6. The preparation method of micronized polyolefin copolymer as claimed in claim 1, wherein in step S140, in the environment of continuous high shear of said co-rotating twin screw extruder, said surfactant is used to prevent said polyolefin resin containing unsaturated carboxylic acid from forming a continuous phase again, and then the particle size becomes smaller and smaller with the screw shear.

7. A preparation method of polyolefin copolymer dry micro powder suitable for processing a polyolefin resin into a polyolefin copolymer dry micro powder with no use of cryogenic grinding, the preparation method of polyolefin copolymer dry micro powder comprising the steps of:
S210: performing functional group reactive grafting on a polyolefin resin to become a polyolefin resin containing unsaturated carboxylic acid;
S220: putting said polyolefin resin containing unsaturated carboxylic acid into a co-rotating twin screw extruder;
S230: dissolving a surfactant in water and stirring until dissolved, then injecting the aqueous surfactant solution thus obtained into said co-rotating twin screw extruder through a high-pressure pump;
S240: performing continuous high shearing on said polyolefin resin containing unsaturated carboxylic acid in water through said co-rotating twin screw extruder, so that said polyolefin resin containing unsaturated carboxylic acid is mixed with water in a molten state;
S250: said polyolefin resin containing unsaturated carboxylic acid forming tiny particles and being evenly dispersed in water to form an aqueous polyolefin dispersion;
S260: rapidly cooling said aqueous polyolefin dispersion; and
S270: removing the moisture of said aqueous polyolefin dispersion through a dehydration process to obtain a polyolefin copolymer dry micro powder.

8. The preparation method of polyolefin copolymer dry micro powder as claimed in claim 7, wherein in the step of performing functional group reactive grafting on said polyolefin resin, said polyolefin resin is selectively combined with maleic anhydride or methacrylic acid to perform functional group reactive grafting.

9. The preparation method of polyolefin copolymer dry micro powder as claimed in claim 7, wherein said polyolefin resin is ethylene-propylene copolymer.

10. The preparation method of polyolefin copolymer dry micro powder as claimed in claim 7, wherein said aqueous polyolefin dispersion is formed of polyolefin particles dispersed in water and the particle size is less than 10 microns.

11. The preparation method of polyolefin copolymer dry micro powder as claimed in claim 7, wherein the polyolefin in said aqueous polyolefin dispersion has a solid content of 40˜60 wt % and a viscosity of 300˜80,000 centipoise (cP).

12. The preparation method of polyolefin copolymer dry micro powder as claimed in claim 7, wherein in step S240, in the environment of continuous high shear of said co-rotating twin screw extruder, said surfactant is used to prevent polyolefin resin containing unsaturated carboxylic acid from forming a continuous phase again, and then the particle size becomes smaller and smaller with the screw shear.
